(19) United States
(12) Patent Application Publication
(10) Pub. No.: US 2005/0069010 A1
(43) Pub. Date: Mar. 31, 2005

(54) Laser apparatus and image display using the same

(75) Inventors: Hideaki Okano, Yokohama-shi (JP); Masaki Tsuchida, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/947,404

(22) Filed: Sep. 23, 2004

(30) Foreign Application Priority Data
Sep. 30, 2003 (JP) 2003-340695

(51) Int. Cl. H01S 3/091

(52) U.S. Cl. 372/70; 372/72; 372/68

(57) ABSTRACT

A laser apparatus according to this invention includes an optical resonator, which has a mirror capable of enclosing light with a required output wavelength and light with a first non-required output wavelength able to increase the efficiency of generating the light with the required output wavelength, in an optical fiber, at both ends of an optical fiber added with ions capable of generating light with a required output wavelength, and damping or discharging light with a second non-required output wavelength to suppress generation of light with the required output wavelength, to outside.

### CROSS-REFERENCE TO RELATED APPLICATIONS

This application is based upon and claims the benefit of priority from prior Japanese Patent Application No. 2003-340695, filed Sep. 30, 2003, the entire contents of which are incorporated herein by reference.

### BACKGROUND OF THE INVENTION

1. Field of the Invention

The present invention relates to a laser apparatus applicable to a wide variety of fields, such as displays and recording apparatus.

2. Description of the Related Art

A laser apparatus has been proposed, which adds thulium ions (Tm³⁺) to a core of an optical fiber, and provides a blue laser beam with a wavelength of 455 nm by upconversion. In this apparatus, oscillation is confirmed but not efficient, and a large output suitable for displays is not obtained.

Jpn. Pat. Appln. KOKAI Publication No. 7-226551 proposed a method of obtaining a 455 nm laser beam by adding terbium ions (Tb³⁺) with Tm³⁺ and increasing a pumping efficiency to an upper level ¹D₂ of 455 nm by using an interaction between Tm³⁺ and Tb³⁺. The Publication also confirmed oscillation of a 455 nm laser beam.

A method of oscillating a wavelength of 455 nm by using excitation lights with wavelengths of 645 nm and 1064 nm was proposed in M. P. Le Flohic et. Al. “Room-temperature continuous-wave upconversion laser at 455 nm in a Tm³⁺fluorozirconate fiber”, Optics Letters, Vol. 19, No. 23, 1994, p.p. 1982 to 1984. The document disclosed that population inversion of a wavelength of 455 nm can be increased by decreasing the distribution density of ³H₄ by exciting electrons in ³D₄, a lower level of 455 nm, to ³F₂ by an excitation light of 1064 nm.

However, the method described in Jpn. Pat. Appln. KOKAI Publication No. 7-226551 is high in the oscillation threshold value, and the output is merely several +mW.

In the method described in “Room-temperature continuous-wave upconversion laser at 455 nm in a Tm³⁺ fluorozirconate fiber”, though not described, as an excitation light with a wavelength of 1064 nm excites not only ³H₄ but also electrons of ¹D₂ to a higher level, the distribution density of the lower level of the wavelength 455 nm is lowered, and the distribution density of a higher level is also decreased. A wavelength of 455 nm can be oscillated resultantly, but the efficiency is not high. In transition of emission from ¹D₂ to a lower level, ultraviolet light is generated, which may damage the glass of the mother material.

### BRIEF SUMMARY OF THE INVENTION

According to an aspect of the invention, there is provided a laser apparatus comprising:

An optical resonator which includes a laser medium
with an additive able to absorb an excitation light and generate a laser beam with a given wavelength, and oscillates a laser beam with a first wavelength; and
a pumping source which excites the laser medium of the optical resonator,
wherein the optical resonator is increased in a Q-value for wavelengths near the first wavelength and a second wavelength that is the cause of increasing the efficiency of laser oscillation of the first wavelength, and decreased in a Q-value for a third wavelength that is the cause of decreasing the efficiency of laser oscillation of the first wavelength.

According to another aspect of the invention, there is provided a laser apparatus comprising:
a pumping source which generates an excitation light;
an optical fiber which is added with ions able to absorb the excitation light and generate light with a given wavelength; and
an optical resonator which is provided at both ends of the optical fiber in the axial direction, and includes first and second mirrors that are decreased in the transmissivity for the light with a first wavelength generated in the optical fiber and the light with a second wavelength able to increase the efficiency of generating the light with the first wavelength, and increased in the transmissivity for the light with a third wavelength disturbing generation of the light with the first wavelength, and amplifies the light with the first and second wavelengths by reciprocating in the optical fiber.

According to still another aspect of the invention, there is provided a method of generating a laser beam in an upconversion laser apparatus which has an optical fiber as an optical resonator added with ions capable of absorbing an excitation light and generating light with a given wavelength, comprising:
providing a first mirror and a second mirror, where both ends of an optical fiber added with a given ion capable of generating light with a required output wavelength;
enclosing light with a required output wavelength and light with a first non-required output wavelength able to increase the efficiency of generating the light with the required output wavelength, in an optical fiber, at both ends of an optical fiber added with a given ion capable of generating light with a required output wavelength, with one of the first and the second mirror; and
damping or discharging light with a second non-required output wavelength to suppress generation of light with the required output wavelength, to outside, with one of the first and the second mirror.

According to further another aspect of the invention, there is provided an image display comprising:
a plurality of laser apparatuses which output R, G and B light;
a plurality of spatial modulation elements which spatially modulates the output light from the laser apparatus;
a synthesizing means which synthesizes the R, G and B light modulated spatially by the spatial modulation elements; and
an optical element which forms an image of the output light from the synthesizing means at a given position,
wherein at least one of the plurality of laser apparatus includes a laser apparatus which is increased in a Q-value for wavelengths near a first wavelength and a second wavelength that is the cause of increasing the efficiency of laser oscillation of the first wavelength, and decreased in a Q-value for a third wavelength that is the cause of decreasing the efficiency of laser oscillation of the first wavelength.

According to still another aspect of the invention, there is provided an image display comprising:
a plurality of laser apparatus which outputs R, G and B light;
a plurality of spatial modulation elements which spatially modulate the output light from the laser apparatus;
a synthesizing means which synthesizes the R, G and B light modulated spatially by the spatial modulation elements; and
an optical element which forms an image of the output light from the synthesizing means at a given position,
wherein at least one of the plurality of laser apparatus includes the following configuration:
a pumping source which generates an excitation light;
an optical fiber which is added with ions able to absorb the excitation light and generate light with a given wavelength; and
an optical resonator which is provided at both ends of the optical fiber in the axial direction, and includes first and second mirrors that are decreased in the transmissivity for the light with a first wavelength generated in the optical fiber and the light with a second wavelength able to increase the efficiency of generating the light with the first wavelength, and increased in the transmissivity for the light with a third wavelength disturbing generation of the light with the first wavelength, and amplifies the light with the first, second and third wavelengths by reciprocating in the optical fiber.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic diagram explaining an example of a laser apparatus, which is an embodiment of the invention;

FIG. 2 is an energy level chart explaining the energy transition of Tm³⁺;

FIGS. 3A and 3B are graphs explaining an example of the transmission characteristics of a resonator mirror used in the laser apparatus shown in FIG. 1;

FIG. 4 is a graph showing the changes in the electron distribution density upon excitation of Tm³⁺;

FIG. 5 is a schematic diagram explaining an example of a pumping source usable in the laser apparatus shown in FIG. 1;

FIG. 6 is a schematic diagram explaining another embodiment of the laser apparatus shown in FIG. 1; and

FIG. 7 is a schematic diagram explaining an example of an image display using a laser apparatus, which is an embodiment of the invention.

### DETAILED DESCRIPTION OF THE INVENTION

Embodiments of this invention will now be explained in detail with reference to the accompanying drawings. In all drawings, like components are designated by like reference numerals.

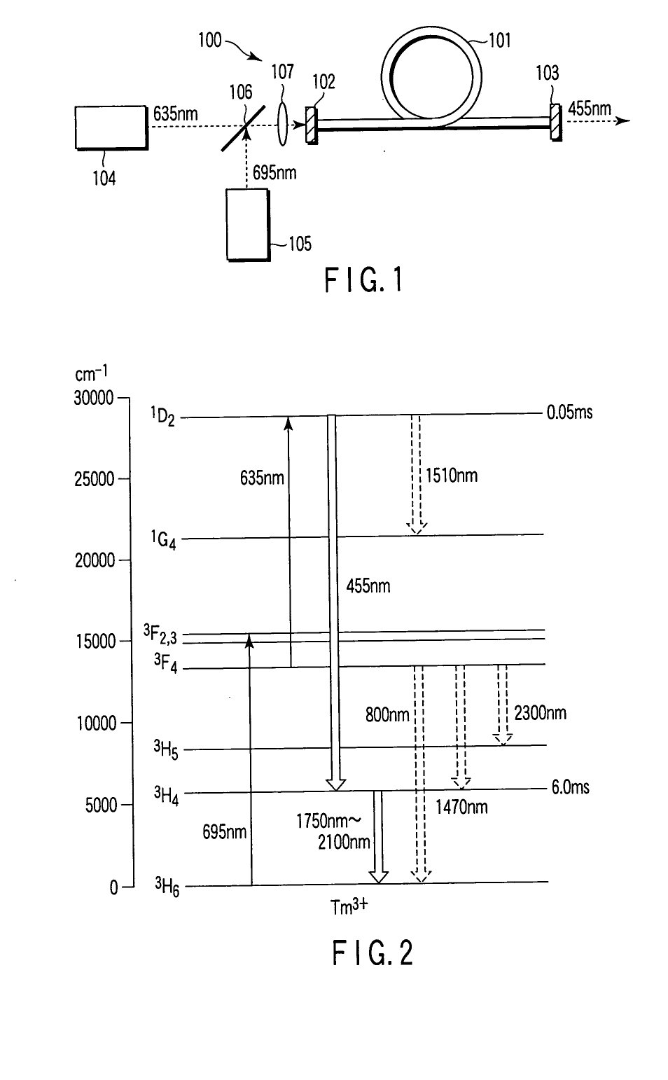

FIG. 1 shows a basic configuration for explaining an embodiment of this invention.

In FIG. 1, an upconversion blue laser apparatus 100 capable of outputting a blue laser beam has an optical fiber 101, and first and second reflection elements 102 and 103 in a core part. The optical fiber (laser medium) is formed by adding thulium ions (Tm³⁺), for example. The reflection elements are mirrors provided at both ends of the optical fiber, and constitute a laser resonator. An output laser beam is emitted from the mirror 103 to outside.

In the side of the mirror 102, there is provided first and second pumping sources 104 and 105 that output an excitation light for exciting Tm³⁺added to the optical fiber 101, a wave synthesizing element that synthesizes the excitation lights from the respective sources (transmissible on the same optical path), a dielectric mirror 106 that transmits totally a first excitation light and reflects totally a second excitation light, for example, and an optics, for example, a lens 107 that inputs the excitation laser beam synthesized by the dielectric mirror 106, to the optical fiber 101 through the mirror 102.

The optical fiber 101 is preferably formed of fluoride fiber using fluoride with small phonon energy as a host. The addition density of Tm³⁺is 1000 to 10000 ppm in weight ratio. The mirrors 102 and 103 are dielectric mirrors.

The first pumping source 104 is a semiconductor laser capable of emitting a laser beam with a wavelength of 630 to 650 nm, preferably 635 nm. The second pumping source 105 is a semiconductor laser capable of emitting a laser beam with a wavelength of 670 to 700 nm, preferably about 695 nm.

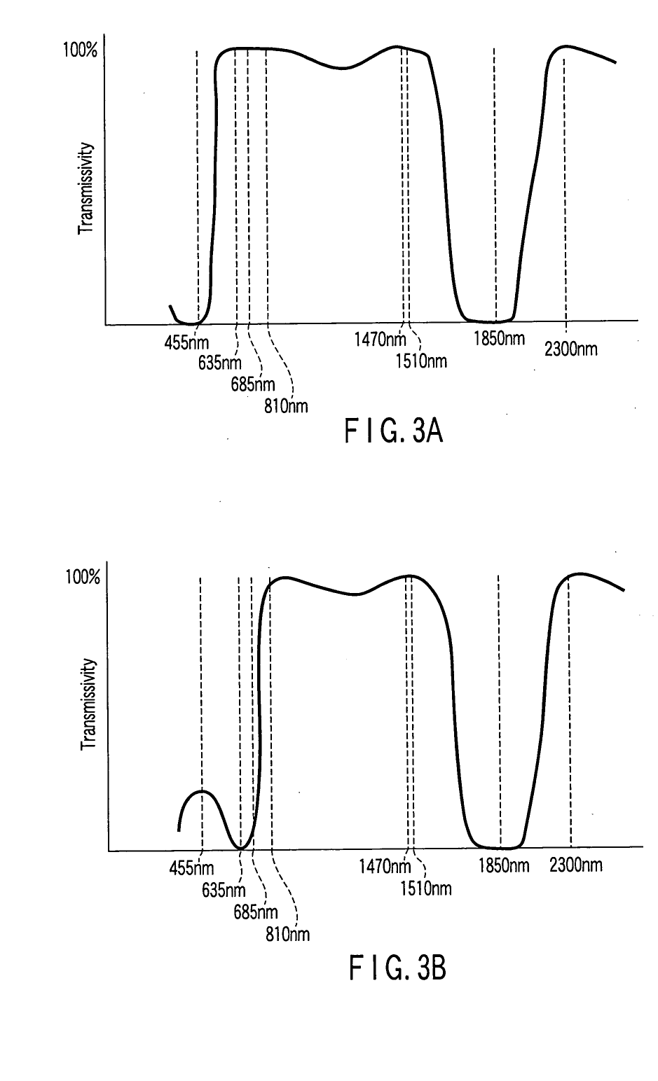

Next, a detailed explanation will be given on the principle and method of obtaining a laser beam of 455 nm with reference to FIG. 1 to FIG. 3. FIG. 2 is an energy level chart explaining the energy transition of Tm³⁺(thulium ion). FIG. 3 shows an example of transmission characteristics of the mirrors 102 and 103, expressing a wavelength in the horizontal axis and a transmissivity in the vertical axis. FIG. 3A shows the transmissivity of the mirror 102. FIG. 3B shows the transmissivity of the mirror 103.

As shown in FIG. 1, excitation laser beams emitted from the semiconductor lasers 104 and 105 are synthesized by the wave synthesizing element 106, and applied to the optical fiber 101 through the optics 107.

The excitation laser beam applied to the optical fiber 101 is absorbed by Tm³⁺added to the optical fiber 101, that is, Tm³⁺is excited by the excitation laser beam.

A blue light with a wavelength of 455 nm is generated from the excited Tm³⁺, and gradually amplified by being reflected repeatedly by the resonator composed of the mirrors 102 and 103 and the optical fiber 101. When the blue light is amplified to larger than a loss of the resonator, a given output blue laser beam of 455 nm is outputted from the resonator, or the mirror 103, to outside.

Explanation will now be given on the excitation state and the principle of oscillating 455 nm by using FIG. 2.

In FIG. 2, electrons in ³H₆ (ground state) absorb the excitation laser beam near a wavelength of 695 nm, and are excited to ³F₂ and ³F₃. The life of these levels is very short, and relaxed to a lower level ³F₄ without emission in very short time.

Electrons of ³F₄ absorb the excitation laser beam near a wavelength of 635 nm, and are excited to ¹D₂. During transition from ¹D₂ to ³H₄, a blue light of 455 nm is generated.

For oscillating a laser beam of 455 nm, it is necessary to form a so-called population inversion state of electrons between a higher level ¹D₂ and lower level ³H₄.

However, as the life of ¹D₂ is as short as 0.05 ms, and the life of ³H₆ is very long, 6 ms, the population inversion state is not easily obtained. Thus, a method of obtaining a blue laser beam by continuous oscillation is not established. As a method of easily obtaining the population inversion state, it is useful to oscillate wavelengths different from the one desired to be finally oscillated, for example, and generate a saturation effect in a resonator.

Therefore, for continuously oscillating a light of 455 nm, it is preferable to maintain the population inversion state between a higher level ¹D₂ and lower level ³H₄. For example, it is preferable to generate transition (oscillation of wavelengths other than 455 nm) from ³H₄ to ³H₆ In the transition from ³H₄ to ³H₆, oscillation of wavelengths of 1700 to 2100 nm is well known. Oscillation of wavelengths of 1700 to 2100 nm can lower the oscillation threshold value of a wavelength of 455 nm.

As shown in FIGS. 3A and 3B, in the present invention, a Q-value of a resonator for oscillation of wavelengths is increased by lowering the transmissivity of wavelength components of 1700 to 2100 nm, or by increasing the reflectivity, in each of the mirrors 102 and 103 constituting a resonator.

Namely, it is useful to increase the light intensity of wavelengths of 1700 to 2100 nm in a resonator, in order to oscillate wavelengths of 1700 to 2100 nm for continuously oscillating a light beam of 455 nm. Therefore, it is desirable to increase maximally the reflectivity of the mirrors 102 and 103 constituting a resonator, for the wavelengths of 1700 to 2100 nm.

By maximizing the reflectivity of the mirrors 102 and 103 of a resonator for the wavelengths of 1700 to 2100 nm in this manner, the population inversion state that is usually impossible between ³H₄ and ¹D₂ becomes possible, and a blue laser of 455 nm can be continuously oscillated.

The population inversion amount between ³H₄ and ³H₆ becomes constant due to the saturation effect of light with wavelengths of 1700 to 2100 nm enclosed in a resonator. As a Q-value of a resonator is higher, the population inversion amount can be made constant in the state that the distribution density of ³H₄ is small.

However, if light with wavelengths of 1700 to 2100 nm is oscillated in the optical fiber 101 with Tm³ ions added, oscillation of 455 nm may be obstructed or the oscillation efficiency may be affected.

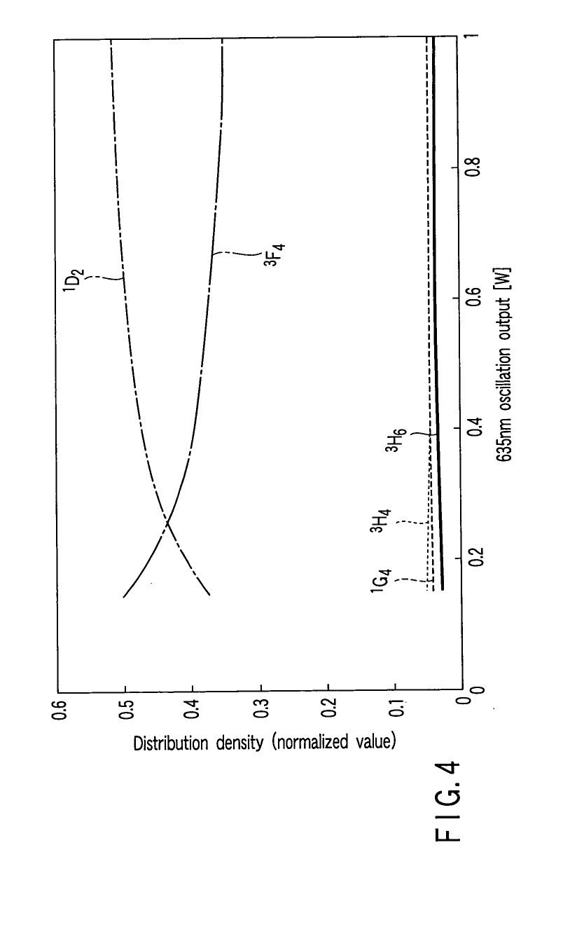

FIG. 4 shows the calculation of the changes in the distribution density of each level upon excitation of a wavelength of 1850 nm. In FIG. 4, the levels with a very short life (³F₂, 3, ³H₅) are ignored. As conditions necessary to obtain the values shown in FIG. 4, the horizontal axis represents the incident strength of 635 nm when an excitation light with a wavelength of 695 nm is applied by 1.0 W to an optical fiber with the Tm³ density of 1000 ppm and the core diameter of 6.5 μm, and the vertical axis represents the normalized distribution density of each level.

According to this calculation, it is seen that there are levels in which the possibility of population inversion and oscillation exist, other than 455 nm shifting from ¹D₂ to ³H₄. The most efficient oscillation among them is a wavelength that shifts from ³F₄ and ¹D₂ with a large distribution density.

According to the energy level chart of FIG. 2 and the density distribution of FIG. 4, it is seen that the easiest levels to oscillate are ³F₄ to ³H₄ (near 1470 nm), ³F₄ to ³H₆ (near 810 nm), ³F₄ to ³H₅ (near 2300 nm) and ¹D₂ to ¹G₄ (1510 nm).

If a laser is oscillated among these levels, it is obvious that it affects oscillation of 455 nm, which lowers the efficiency.

For example, if a laser whose upper level is ³F₄ is oscillated, a saturation effect occurs and the population inversion amount between the oscillation level and the lower levels is saturated, and the distribution density of ³F₄ is not increased or the efficiency of increase is affected. If oscillation of ³F₄ is less, the efficiency of oscillating ¹D₂ becomes small resultantly, causing disturbance to oscillation of 455 nm.

Further, if a laser shifting from ¹D₂ to ¹G₄ is oscillated, saturation occurs in the amount of population inversion between ¹D₂ and ¹G₄, which affects the efficiency of oscillating ¹D₂.

As describe above, the present invention is characterized by the control of a Q-value of a resonator to suppress oscillation of wavelengths that affect the efficiency of oscillating 455 nm.

For example, as shown in FIGS. 3A and 3B, by increasing the transmissivity of the mirrors at both ends of a resonator near wavelengths of 810 nm, 1470 nm, 1510 nm and 2300 nm, the Q-value of the resonator can be lowered, and oscillation of wavelengths that interrupt oscillation of a wavelength of 455 nm can be suppressed.

Namely, oscillation of laser with wavelengths interruptive to oscillation of 455 nm can be suppressed by setting the characteristics (transmissivity or reflectivity) of the mirrors 102 and 103 so as to obtain a resonator, which oscillates only the wavelength between ³H₄ and ³H₆ (1700 to 2100 nm) and 455 nm required for oscillation of 455 nm, as in this invention. This achieves a blue laser apparatus that obtains a large output with high efficiency.

In the embodiment described above, an optical fiber added with Tm³⁺is used as a resonator, but a resonator may be formed of a bulk-shaped crystal or glass.

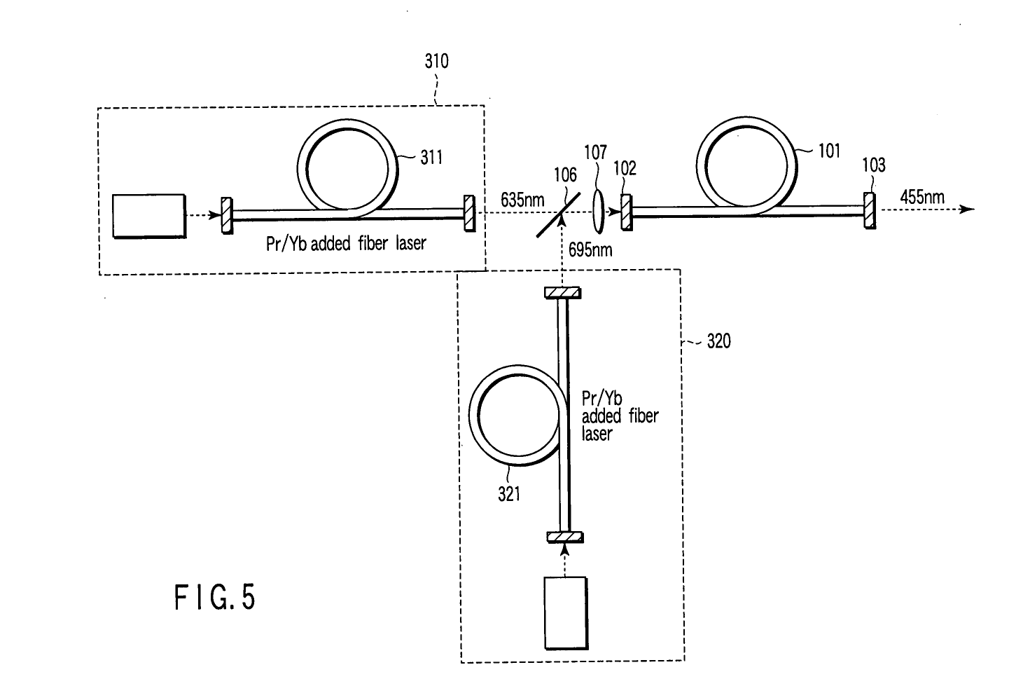

Further, in the configuration shown in FIG. 1, the first and second pumping sources 104 and 105 are not limited to a semiconductor laser but may be other types of light source. For example, as shown in FIG. 5, it is permitted that a fiber added (attached) with praseodymium ions (Pr³⁺) and ytterbium ions (Yb³⁺) is used for the fibers 311 and 321, and when exciting with an excitation light near 850 nm, a laser beam of 635 nm or 695 nm is obtained from each of the upconversion fiber lasers 310 and 320, which can obtain laser beams of 635 nm or 695 nm.

In the configuration shown in FIG. 1, the same effect can be obtained by setting the wavelength of the excitation light outputted from one of the two pumping sources, to 750 to 830 nm, desirably near 790 nm. In this case, the wavelengths of the excitation light can be combined in various ways, for example, 635 nm and 1100 to 1200 nm or a single wavelength near 650 nm.

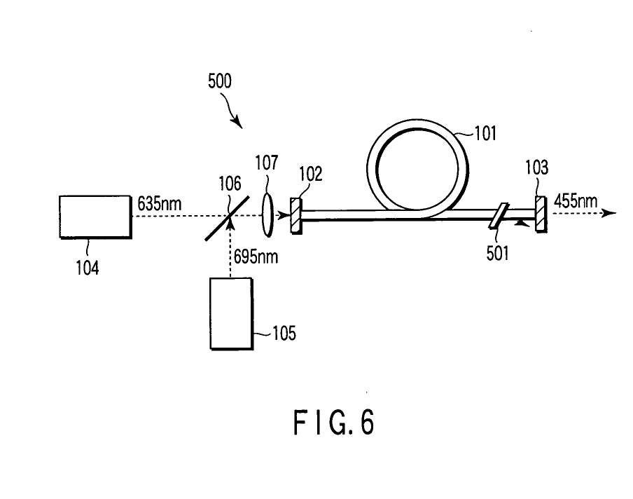

FIG. 6 is a schematic diagram explaining another embodiment different from those shown in FIG. 1 and FIG. 5. Like components (or elements) as those of the configurations shown in FIG. 1 and FIG. 5 are designated by like reference numerals, and a detailed explanation will be omitted.

In FIG. 6, a blue laser apparatus 500 has a Q-value control unit (controlling means=filter) 501, which is provided at both ends of the optical fibers 101 added with Tm³⁺, near one of or both the first and second mirrors 102 and 103, or at a given position in the optical fiber 101, and suppresses amplification of a given wavelength light within a resonator. A dielectric multi-layer filter is preferably used for the filter 501.

As explained with reference to FIG. 1, for efficient continuous oscillation of 455 nm by oscillating a laser with wavelengths of 1700 to 2100 nm by transition from ³H₄ to ³H₆, it is necessary to minimize or set the other (unnecessary) laser oscillation to substantially zero, concretely, oscillation between the levels ³F₄ to ³H₄ (near 1470 nm), ³F₄ to ³H₆ (near 810 nm), ³F₄ to ³H₅ (near 2300 nm), ¹D₂ to ¹G₄ (near 1510 nm). This can be realized by suppressing a Q-value of a resonator for oscillation of the wavelengths unnecessary for oscillation of 455 nm to less than a given value.

The filter 501 is formed to be able to transmit wavelength of 455 nm and most of 1700 to 2100 nm, and reflect most of the wavelengths near 810 nm, 1470 nm, 1510 nm and 2300 nm. The filter 501 is provided at a give angle difficult to amplify oscillation of wavelengths unnecessary for oscillation of 455 nm, with respect to the optical axis of a resonator. Namely, the filter 501 reflects the light with wavelengths unnecessary for oscillation of 455 nm, to outside a resonator. This suppresses the Q-value of a resonator.

Thus, a Q-value of a resonator is controlled to shift from ³H₄ to ³H₆ necessary for oscillation of 455 nm, or to enable oscillation (amplification) of only two wavelengths of 455 nm and 1700 to 2100 nm. This enables a blue laser apparatus capable of emitting a large output with high efficiency.

The filter 501 is not necessarily increased in reflectivity for all wavelengths near 810 nm, 1470 nm, 1510 nm and 2300 nm. It is sufficient for the filter to lower the Q-value for the oscillation of wavelengths unnecessary for oscillation of 455 nm, by cooperating with the transmission (reflection) characteristics of the mirror 102 and the output mirror 103. Namely, if a resonator can suppress oscillation of the wavelengths unnecessary for oscillation of 455 nm to lower than a given level, the suppression degree of each element can be optionally set.

In the configuration explained above, a resonator is composed of an optical fiber added with Tm³⁺, but a resonator is not limited to a fiber, and may be composed of a bulk-shaped crystal or glass.

In the configuration shown in FIG. 6, the first and second pumping sources 104 and 105 are not to be limited to semiconductor lasers, but may use various types of light sources. For example, as explained with reference to FIG. 5, when a fiber added with Pr³⁺ and Yb³⁺ is used and excited by an excitation light near 850 nm, the upconversion fiber lasers 310 and 320, which can obtain laser beams of 635 nm or 695 nm, may be used.

Further, the same effect can be obtained by setting the wavelength of the excitation light outputted from one of the two pumping sources, to 750 to 830 nm, desirably near 790 nm. In this case, combination of the wavelengths of excitation light can be selected from 635 nm and 1100 to 1200 nm, or a single wavelength near 650 nm.

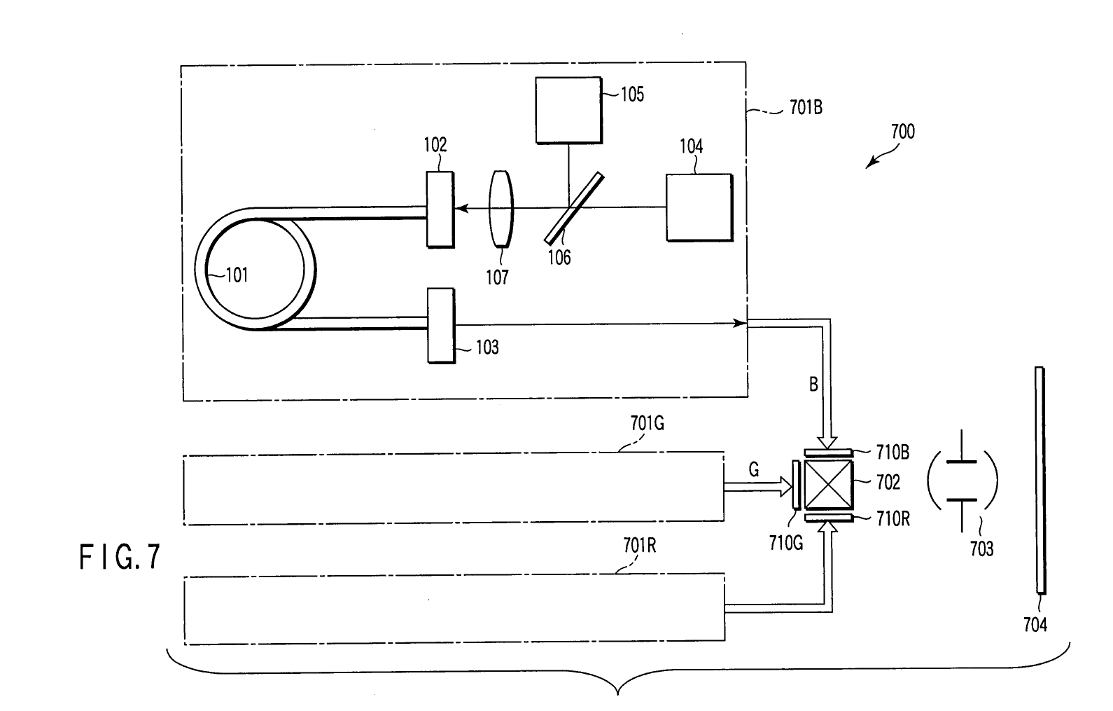

FIG. 7 is a schematic diagram explaining an example of an image display using a blue laser apparatus shown in FIG. 1 as a light source.

As shown in FIG. 7, an image display 700 has first to third light sources 701R, 701G and 701B for displaying a color image by an additive color mixture method. At least one of these light sources, for example, the light source 701B for B uses a laser apparatus explained with reference to FIG. 1 (designated by a reference numeral 100 in FIG. 1).

The fiber laser apparatus 701R, 701G and 701B emit R, G and B light with given intensity.

The light emitted from the laser apparatus 701R, 701G and 701B is applied to liquid crystal panels 710R, 710G and 710B for displaying the R, G and B images, and spatially modulated.

The spatially modulated R, G and B lights are synthesized by a synthesizing means 702, such as, a dichroic prism, and applied to a projection lens 703.

The light projected from the projection lens 703 is displayed as a color image on a screen 704.

In the image display shown in FIG. 7, the light from the light sources 701R (red), 701G (green) and 701B (blue) are spatially modulated by the liquid crystal panels 710R, 710G and 710B, and synthesized by the synthesizing means 702. It is of course possible to use one liquid crystal panel, generate a white light from the light from the light sources applied to the projection lens 703, and irradiate the white light to the liquid crystal panel.

According to this invention, it is possible to provide a means of obtaining a blue laser of high output and high efficiency, by controlling a Q-value of a resonator.

According to the invention, in an image display, a light emitting output from a laser apparatus capable of outputting optional colors (R, G, B) is increased, and the size of an image display is reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A laser apparatus comprising:
An optical resonator which includes a laser medium
with an additive able to absorb an excitation light and generate a laser beam with a given wavelength, and oscillates a laser beam with a first wavelength; and
a pumping source which excites the laser medium of the optical resonator,
wherein the optical resonator is increased in a Q-value for wavelengths near the first wavelength and a second wavelength that is the cause of increasing the efficiency of laser oscillation of the first wavelength, and decreased in a Q-value for a third wavelength that is the cause of decreasing the efficiency of laser oscillation of the first wavelength.

2. The laser apparatus according to claim 1, wherein the laser medium includes a thulium ion (Tm³⁺).

3. The laser apparatus according to claim 2, wherein the first wavelength includes wavelengths near 455 nm, and the second wavelength includes wavelengths near 1700 to 2100 nm.

4. The laser apparatus according to claim 1, wherein the third wavelength includes at least one of the wavelengths near 810 nm, 1470 nm, 1510 nm and 2300 nm.

5. The laser apparatus according to claim 1, further comprising a suppressing means for suppressing oscillation of the third wavelength.

6. The laser apparatus according to claim 1, wherein the optical resonator is high in the reflectivity for laser oscillation of the first and second wavelengths (compared with other wavelengths).

7. The laser apparatus according to claim 1, wherein the laser medium includes an optical fiber.

8. The laser apparatus according to claim 1, wherein the pumping source includes a first pumping source to generate an excitation light with wavelengths of 630 to 650 nm, and a second pumping source to generate an excitation light with wavelengths of 670 to 700 nm.

9. The laser apparatus according to claim 8, wherein the first and second pumping sources include an optical fiber added with praseodymium ion (Pr³⁺) and ytterbium ion (Yb³⁺), and a pumping source which excites them, each.

10. The laser apparatus according to claim 1, wherein the pumping source includes a first pumping source which generate an excitation light with wavelengths of 630 to 650 nm, and a second pumping source which generates an excitation light with a wavelength of 750 to 830 nm.

11. A laser apparatus comprising:
a pumping source which generates an excitation light;
an optical fiber which is added with ions able to absorb the excitation light and generate light with a given wavelength; and
an optical resonator which is provided at both ends of the optical fiber in the axial direction, and includes first and second mirrors that are decreased in the transmissivity for the light with a first wavelength generated in the optical fiber and the light with a second wavelength able to increase the efficiency of generating the light with the first wavelength, and increased in the transmissivity for the light with a third wavelength disturbing generation of the light with the first wavelength, and amplifies the light with the first and second wavelengths by reciprocating in the optical fiber.

12. The laser apparatus according to claim 11, wherein the first wavelength includes wavelengths near 455 nm, and the second wavelength includes wavelengths near 1700 to 2100 nm.

13. The laser apparatus according to claim 11, wherein the third wavelength includes at least one of the wavelengths near 810 nm, 1470 nm, 1510 nm and 2300 nm.

14. The laser apparatus according to claim 11, further comprising a suppressing means for suppressing oscillation of the third wavelength.

15. A method of generating a laser beam in an upconversion laser apparatus which has an optical fiber as an optical resonator added with ions capable of absorbing an excitation light and generating light with a given wavelength, comprising:
providing a first mirror and a second mirror, where both ends of an optical fiber added with a given ion capable of generating light with a required output wavelength;
enclosing light with a required output wavelength and light with a first non-required output wavelength able to increase the efficiency of generating the light with the required output wavelength, in an optical fiber, at both ends of an optical fiber added with a given ion capable of generating light with a required output wavelength, with one of the first and the second mirror; and
damping or discharging light with a second non-required output wavelength to suppress generation of light with the required output wavelength, to outside, with one of the first and the second mirror.

16. An image display comprising:
a plurality of laser apparatuses which output R, G and B light;
a plurality of spatial modulation elements which spatially modulates the output light from the laser apparatus;
a synthesizing means which synthesizes the R, G and B light modulated spatially by the spatial modulation elements; and
an optical element which forms an image of the output light from the synthesizing means at a given position,
wherein at least one of said plurality of laser apparatus includes a laser apparatus which is increased in a Q-value for wavelengths near a first wavelength and a second wavelength that is the cause of increasing the efficiency of laser oscillation of the first wavelength, and decreased in a Q-value for a third wavelength that is the cause of decreasing the efficiency of laser oscillation of the first wavelength.

17. An image display comprising:
a plurality of laser apparatus-which outputs R, G and B light;
a plurality of spatial modulation elements which spatially modulate the output light from the laser apparatus;
a synthesizing means which synthesizes the R, G and B light modulated spatially by the spatial modulation elements; and
an optical element which forms an image of the output light from the synthesizing means at a given position,
wherein at least one of said plurality of laser apparatus includes the following configuration:
a pumping source which generates an excitation light;
an optical fiber which is added with ions able to absorb the excitation light and generate light with a given wavelength; and
an optical resonator which is provided at both ends of the optical fiber in the axial direction, and includes first and second mirrors that are decreased in the transmissivity for the light with a first wavelength generated in the optical fiber and the light with a second wavelength able to increase the efficiency of generating the light with the first wavelength, and increased in the transmissivity for the light with a third wavelength disturbing generation of the light with the first wavelength, and amplifies the light with the first, second and third wavelengths by reciprocating in the optical fiber.
